(19) United States
(12) Patent Application Publication
(10) Pub. No.: US 2019/0151980 A1
(43) Pub. Date: May 23, 2019

(54) METHOD FOR JOINING VERY THICK TUBULAR PARTS BY MAGNETIC PULSES AND CORRESPONDING ARTICLE

(71) Applicant: ADM28 S.ÀR.L, LUXEMBOURG (LU)

(72) Inventor: VICTOR SHRIBMAN, KIRYAT ONO (IL)

(21) Appl. No.: 16/099,650

(22) PCT Filed: May 9, 2017
(86) PCT No.: PCT/EP2017/061022

§ 371 Date: Nov. 7, 2018

(30) Foreign Application Priority Data
May 10, 2016 (FR) 16 54167

(51) Int. Cl. B23K 20/06

(52) U.S. Cl. CPC B23K 20/06; B23K 13/025

(57) ABSTRACT

A method for joining two tubular parts, an internal part and an external part, by magnetic pulses. The external part includes an annular wall having an outer surface. Over a longitudinal portion of the external part, a thickness of the annular wall of the external part is reduced such that the annular wall has a decreasing thickness over the longitudinal portion. The tubular parts are positioned one inside the other to form an overlap region covering the longitudinal portion. The tubular parts are positioned next to a coil such that the longitudinal portion is disposed opposite an active part of the coil. The two tubular parts are connected by magnetic pulses.

### FIELD OF THE INVENTION

The present invention falls within the field of joining of parts by magnetic pulses. The present invention relates to a method for joining tubular parts. The invention is particularly applicable to very thick tubular parts.

### STATE OF THE ART

Magnetic-pulse welding belongs to the field of impact-welding methods used for producing a connection between two metal parts by pressing against each other at an overlap region. The principle of such a magnetic-pulse welding method is based mainly on the high-speed impact of parts by electromagnetic forces generated by a coil.

Conventionally, a system for implementing such a magnetic-pulse welding method comprises one or more capacitors(s) connected to a coil for creating a short and intense magnetic field. The capacitor(s) is/are used to store a large amount of electrical energy. The intense magnetic field created is the result of a very rapid discharge of this electrical energy in the coil.

To weld two pieces together using this method, said two parts are first superposed with respect to each other, at least on one area referred to as the overlap region. The coil is positioned at this overlap region. The part referred to as the external part is the one that is positioned close to the coil, without being in contact with it, and the part referred to as the internal part is one that is further away from the coil. A very large amount of electrical energy, stored beforehand in the capacitor(s), is suddenly discharged into the coil, in the form of a variable current of very high intensity, in a very short time. For example, some systems can reach several hundred thousands of amperes in a few microseconds. The current generates a variable magnetic field between the coil and the external part and induces eddy currents in the external part. These eddy currents, combined with the surrounding magnetic field, develop significant body forces called Lorentz forces in the external part. These forces generate a strong acceleration of the external part towards the internal part. The impact speed of the external part on the internal part can reach several hundred m/s. When certain impact conditions, especially the impact angle and impact speed, are met, the impact generates, firstly, a jet of material that will clean the surface of both parts, and secondly, a pressure will bring the atoms of the materials of the two parts against each other such that their natural repulsion forces are overcome, thereby resulting in a metal bond without melting. The wall of the external part is then not only connected from a metallurgical point of view to the wall of the internal part, but it has also undergone a compression set.

However, contact between the two pieces is not a guarantee of welding.

For the welding to take place, several parameters must be considered, particularly the impact angle and the impact speed. These two parameters are related to the initial relative arrangement of the coil and the two parts to be welded, to the materials of the parts and to the current signal used.

To reiterate, the impact speed is the radial impact speed between the two parts. We also define the impact point speed which is tangential to the parts. The impact speed and the impact point speed are related by the angle of impact. The impact speed and impact point speed change on impact. The impact point speed can reach several thousand m/s.

The impact angle is defined as the angle between the walls of the two parts during the impact. The impact angle is dynamic, that is to say, it changes during the impact, especially because the external part deforms unevenly.

It turns out that the welding of two very thick parts, especially tubular parts, is difficult to achieve because the conditions necessary for the welding are difficult to meet.

A very thick part refers to a part made up of a wall having a thickness of at least 3 mm.

Hence, very thick parts can be joined only by crimping, which offers lower performance in terms of mechanical strength than welding.

### DISCLOSURE OF THE INVENTION

This invention aims to remedy the aforementioned drawbacks.

The present invention is intended to provide an effective solution for joining very thick parts, especially tubular parts, while also ensuring the mechanical strength of the resulting article.

Additional objectives of the invention are that the method is simple and quick to implement.

To this end, this invention proposes a magnetic pulse method for joining two tubular parts, an internal part and an external part, with said external part comprising an annular wall having an outer surface. The method comprises the steps of:
reducing, in a longitudinal portion of the external part, a thickness of the annular wall of the external part such that the annular wall has a thickness that decreases on said longitudinal portion,
positioning of the two tubular parts one into the other, forming an overlap region that at least covers the longitudinal portion,
positioning of the two tubular parts opposite a coil, such that the longitudinal portion is arranged opposite an active part of said coil,
connecting the two tubular parts by magnetic pulses.

Tubular parts refer to parts have the form of a tube over all or part of their length, and at least at the overlap region.

The external part should preferably have an inner diameter that is greater than an outer diameter of the internal part.

Active part refers to an area of the coil where current, supplied by an electricity storage unit, is concentrated and flows for creating a magnetic field at an opening of the coil. A thickness of the active part corresponds approximately to the skin thickness. At high frequency, the current flows through a reduced thickness corresponding to the skin thickness. The frequency used in the magnetic pulse welding is a few tens of kHz, which corresponds, for example, to a skin thickness of a few millimetres for a coil made of steel.

The thickness of the annular wall of the external part can be reduced by removing a layer of material from its outer surface.

The external part has an inner surface that is more or less flat and an outer surface that has, at the longitudinal portion, an angle with said inner surface of the external part.

The external part has an approximately constant inner diameter in the overlap region, especially in the longitudinal portion. In other words, the annular wall of the external part has an inner surface that is approximately parallel to an outer surface of an annular wall of the internal part, in the overlap region, and especially in the longitudinal portion. The positioning of the two parts relative to each other is facilitated in this manner. Furthermore, at the bonding step, this configuration (outer surface of the internal part parallel to the inner surface of the external part) does not cause a discontinuity, especially with respect to changes in the main parameters, i.e. the impact angle and the impact speed.

The step of bonding the two tubular parts by magnetic pulses consists of subjecting an area, referred to as the working area, to a magnetic field created by the coil such that a pressure is exerted on the annular wall of the external part which pushes it tightly against an annular wall of the internal part by bonding them permanently.

Thus, when the working area is subjected to the magnetic field generated by the coil used for the pressure welding, the two tubular parts are tightly pressed against one another by accelerating and deforming the tubular part closest to the coil, which in this case is the external part, towards the other tubular part, i.e. the internal part.

When the internal part is engaged in the external part, the outer surface of the annular wall of the internal part is approximately parallel to the inner surface of the annular wall of the external part. Upon application of a magnetic field by the coil on the two tubular parts, the magnetic pressure generated by the Lorentz forces is approximately perpendicular to the annular wall of the external part, which is opposite the coil. Since the external part has an annular wall of varying thickness, the magnetic pressure forces the external part to rotate, facilitating the creation of an angle, i.e. the angle of impact between the two tubular parts. This creates a preferential framework for obtaining the conditions required for welding.

The joining method according to the invention consequently makes it possible to carry out, over a certain length, welding between the two tubular parts where the thickness of the annular wall of the external part is low, followed by crimping.

The bonding obtained between the two tubular parts is stronger than what can be obtained through simple crimping, without compromising the structural strength of the external part.

The mechanical strength of the article obtained from the bonding of the two tubular parts by the joining method is thus improved.

According to specific modes of implementation, the method according to the invention further satisfies the following characteristics, implemented separately or in each of their technically operating combinations. In the specific embodiments of the invention, the thickness of the annular wall of the external part is reduced such that the thickness is monotonically decreasing towards a first end of the outer part. Such an embodiment allows, on the one hand, simplifying the manufacturing of the external part and on the other hand, a regular distribution of residual stresses in the external part.

In specific embodiments of the invention, the thickness of the annular wall of the external part is reduced such that the thickness is constant over a first portion of the longitudinal portion, and then monotonically increasing on a second portion of the longitudinal portion.

Since the wall is thinner over a greater length than in the previous embodiments, the welding length will consequently be greater. The mechanical strength of the resulting article is improved even further.

Thin refers to a thickness of less than 3 mm.

In specific embodiments of the invention, the thickness of the annular wall of the external part is also reduced by removing a layer of material from an inner surface of said external part.

The external part thus has an outer surface that is approximately flat and an inner surface that forms, at the longitudinal portion, an angle with an outer surface of the internal part.

The outer surface of the annular wall of the external part and the outer surface of the annular wall of the internal part are more or less in alignment with each other, without blistering at the welded portion.

Preferably, the thickness of the annular wall of the external part is reduced by machining.

In specific embodiments of the invention, the method comprises a step of forming at least one pattern on an outer surface of an annular wall of the internal part, with said forming step being prior to the positioning steps.

Said at least one pattern is preferably located, when the two tubular parts are subsequently arranged one inside the other, in the longitudinal portion.

Said at least one pattern is preferably designed to strengthen the bonding between the two tubular parts, by blocking any rotation and/or forward movement of the parts with respect to each other.

In an example of implementation, the at least one pattern is sunken or protruding, transversal or radial.

Preferably, the at least one pattern is formed by machining.

Preferably, the step of forming the at least one pattern and the step for reducing the thickness of the annular wall of the external part are performed simultaneously. This helps to save time and manufacturing costs.

The invention also relates to an article comprising two tubular parts, the external part having a decreasing thickness in the longitudinal portion, said two tubular parts being joined together at the longitudinal portion, successively by a welded portion and a crimped portion, said welded and crimped portions being obtained by means of the joining method according to at least one of its embodiments.

### DESCRIPTION OF THE FIGURES

The invention will be better understood from reading the following description with reference to the accompanying drawings:

FIG. 1 shows a schematic of a perspective view of a joining device;

FIG. 2 illustrates a perspective view of a yoke and a tube prior to joining;

FIG. 3 shows a cross section of an annular coil of the joining device of FIG. 1, in which two tubular parts are positioned, the external part showing a first embodiment;

FIG. 4 shows a cross section of an annular coil of the joining device of FIG. 1, in which two tubular parts are positioned, the external part showing a second embodiment;

FIG. 5 shows a cross section of an annular coil of the joining device of FIG. 1, in which two tubular parts are positioned, the external part showing a third embodiment;

FIG. 6 shows a cross section of an annular coil of the joining device of FIG. 1, in which two tubular parts are positioned, the external part showing a fourth embodiment, and the tubular opening of the coil showing an alternative embodiment; and

FIG. 7 shows a cross section of an annular coil of the joining device of FIG. 1, in which two tubular parts are positioned, the tubular opening of the coil showing an alternative embodiment.

### DETAILED DESCRIPTION OF AN EMBODIMENT OF THE INVENTION

The invention is now described in detail in the case of joining two tubular parts 2, 3, preferably very thick parts.

A particularly preferred field of application of the invention, although not being limitative in any way, is the automotive industry. In a preferred embodiment, the invention is particularly suitable for the joining of a tubular part 2′ and a mechanical yoke 3′, as illustrated in FIG. 2.

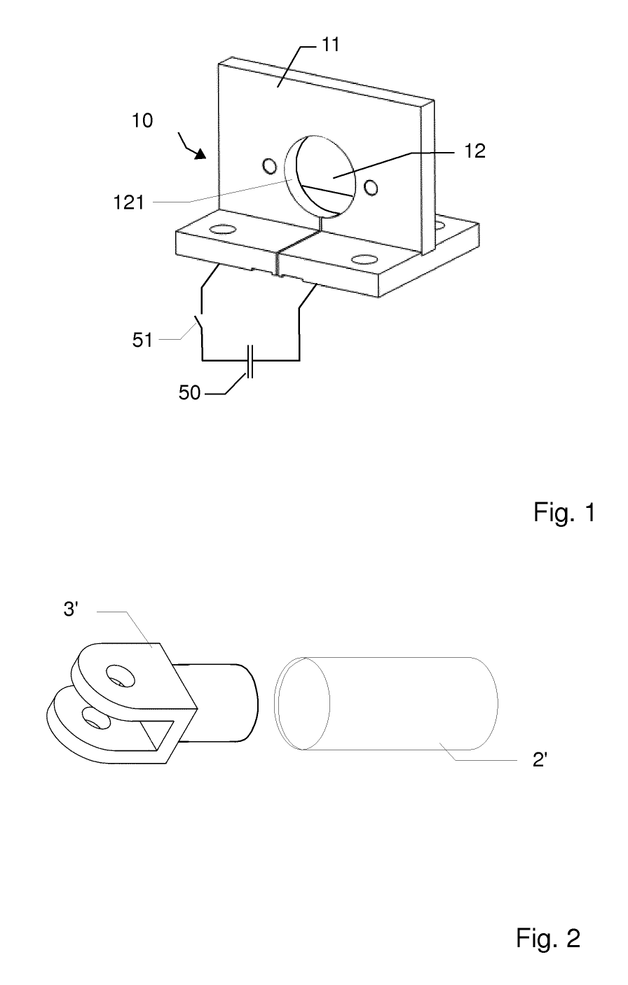

FIG. 1 describes a joining device by magnetic pulses. In the following description, such a device shall be referred to as a joining device.

The joining device is known to comprise a coil 10, a storage unit 50 and one or more switches 51.

The storage unit 50 is configured and designed for storing significant amounts of energy, for example up to several tens of kilojoules (kJ).

In a preferred embodiment, the storage unit is a battery of discharge capacitors.

The coil 10 is in turn configured and designed for creating a concentrated magnetic field in a limited space, described later.

The joining device is designed to hold the two tubular parts 2, 3 for joining.

The two tubular parts 2, 3 are, in the following description, of circular cross-section. Although the tubular parts 2, 3 are described and illustrated in detail in the case of a circular cross section, other cross-sectional shapes, such as square, rectangular, triangular or oval, may also apply.

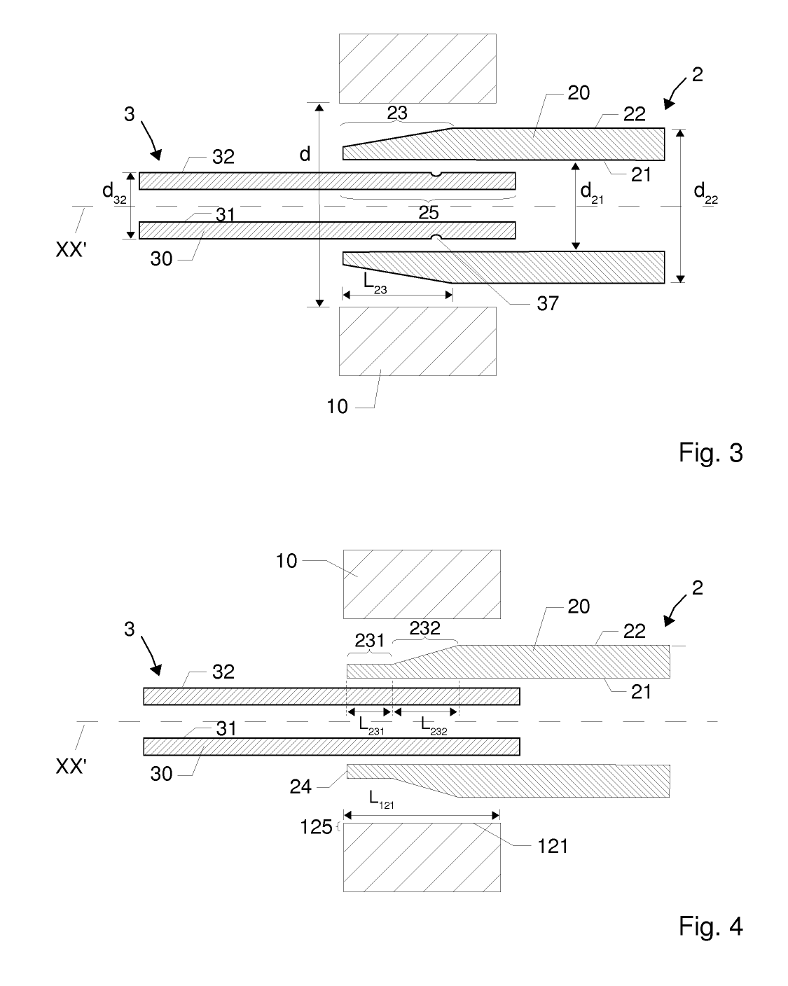

A first tubular part, referred to as the external part 2, comprises an annular wall 20 having an inner surface 21 and an outer surface 22, as illustrated in FIGS. 3 and 4.

A second tubular part, referred to as the internal part 3, comprises an annular wall 30 having an inner surface 31 and an outer surface 32, as also illustrated in FIGS. 3 to 7.

The external part 2 has an inner diameter d₂₁ that is greater than an outer diameter d₃₂ of the internal part 3, such that the internal part 3 can penetrate into the external part 2, with clearance.

The two tubular parts 2, 3 are designed to be arranged one inside the other coaxially, forming, where they overlap, an overlap region 25, and then to be joined irreversibly by magnetic pulses, across all or a part of said overlap region 25 by the coil 10, as will be described later.

The coil 10 and the two tubular parts 2, 3 form a welding joining when said two tubular parts are in position with said coil.

Preferably, the overlap region 25 is located at one end of at least one part, for example an end of the external part 2.

The two tubular parts are preferably made of a metallic material.

In an example of an embodiment, the two tubular parts are made of the same material.

In another example of an embodiment, the two tubular parts are made of different materials.

As a non-limiting example of the invention, the internal part and the external outer part may be made of steel or aluminium respectively.

In the non-limiting example where the internal part 3 and external part 2 are made of steel or aluminium, the annular walls of the external part and the internal part are more than 3 mm thick.

In an embodiment that is not shown here, when the external part 2 is made of a material having a very low electrical conductivity, such as a part made of steel for instance, an intermediate part, called a pusher, which is preferably tubular with a circular section, is positioned against the outer surface 22 of the annular wall 20 of the external part 2. This intermediate part has a good electrical conductivity.

A material with a very low electrical conductivity refers to a material whose electrical conductivity is less than 10 MS/m.

The coil 10, preferably an annular coil, comprises, as illustrated in FIG. 1, a body 11 that has tubular opening 12 delimited by a peripheral surface 121. Said tubular opening is configured to hold the two tubular parts 2, 3 arranged one inside the other for their joining. In other words, the tubular opening 12 has a circular cross section whose diameter d is larger than an outer diameter d₂₂ of the external part 2.

The body 11 is made of a material with specific characteristics in terms of, on the one hand, mechanical resistance to plastic deformation in order to withstand the circulation of a very high intensity current of approximately several hundreds of thousands of amperes and, on the other hand, resistance to elevated temperatures (i.e. a high melting point) to ensure that it does not melt during welding.

In an example of an embodiment, the body is made of steel.

The coil 10 is connected to the energy storage unit 50 and to the switch/switches 51.

In operation, when the switch/switches 51 close(s), the body of the coil 10 is connected to the storage unit 50, and a very high intensity current flows in the coil 10 producing a magnetic field.

The coil 10 is designed such that the current density in an area of the coil is sufficient to meet the welding conditions. This area is referred to as the active part 125. It is described in document WO 2012/103873, for instance.

In the case of an annular coil as described in this embodiment, the current is concentrated in the active part 125, on a layer delimited by the peripheral surface 121 opposite the outer surface 22 of the external part 2 and on a thickness corresponding to the skin thickness. The current thus generates a concentrated magnetic field in the tubular opening 12.

In the non-limiting example of a coil 10 made of steel, the skin thickness is approximately a few millimetres at a frequency of a few tens of kHz.

A method for joining two tubular parts 2, 3 according to the invention is now described. The joining method is preferably carried out by the previously described joining device.

The method comprises a first step of reducing the thickness of the annular wall 20 of the external part 2, over a longitudinal portion 23 of length L₂₃.

The thickness of the annular wall 20 of the external part 2 is reduced such that the external part 2 has, on the longitudinal portion 23, an annular wall 20 of decreasing thickness towards a first end 24.

Preferably, but not limiting in any way, the longitudinal portion 23 extends from the first end 24 of the external part 2.

The longitudinal portion 23 is located on the external part 2, such that it is in the overlap region 25 of the two tubular parts 2, 3, when said two tubular parts are positioned one inside the other, for subsequent bonding.

The length L₂₃ of the longitudinal portion 23 is defined such that at the most, it is equal to an axial length L₁₂₁ of the peripheral surface 121 of the coil 10.

According to one preferred embodiment, as illustrated in FIGS. 3 to 7, the thickness of the annular wall 20 is reduced by removing a layer of material from the outer surface 22.

According to an alternative embodiment, the thickness of the annular wall 20 is reduced by removing a layer of material from the inner surface 21.

According to another alternative embodiment, the thickness of the annular wall 20 is reduced by removing a layer of material from the outer surface 22 and the inner surface 21.

Whatever the embodiment or alternative embodiment, a layer of material is removed until the annular wall 20 has, over the length of the longitudinal portion 23, a decreasing thickness towards the first end 24.

In other words, when the longitudinal portion starts from the first end 24 of the external part 2, the thickness of the removed layer decreases from the first end 24, over the longitudinal portion. The thickness of the annular wall 20 of the external part 2, in turn, increases over the longitudinal portion 23, from the first end 24.

Preferably, the thickness of the annular wall 20 of the external part 2 at the first end 24 is reduced to 1 mm.

One way to implement this first step is, for example, to reduce the thickness of the annular wall of the external part by machining.

In an example of an embodiment, the thickness of the annular wall 20 of the external part 2 is reduced such that the thickness of said annular wall 20 monotonically decreases over the length L₂₃ of the longitudinal portion 23 towards the first end 24. In the illustration given in FIG. 3, without this being limiting in any way, the thickness of the annular wall 20 of the external part 2 is only reduced from the outer surface 22. No changes are made to the outer surface 32 of the annular wall 30 of the internal part 3. The inner diameter d₂₁ of the external part 2 remains constant over said longitudinal portion 23.

In an alternative embodiment, the thickness of the annular wall 20 of the external part 2, over the length of the longitudinal portion, is reduced such that:
over a first portion 231 of the longitudinal portion 23, the thickness of said annular wall 20 is constant,
over a second portion 232 of the longitudinal portion, the thickness of said annular wall 20 of the external part is monotonically increasing.

In the illustration given in FIG. 4, without this being limiting in any way, the thickness of the annular wall 20 of the external part 2 is only reduced from the outer surface 22. No changes are made to the outer surface 32 of the annular wall 30 of the internal part 3. The inner diameter d₂₁ of the external part 2 remains approximately constant in the overlap region, especially over said longitudinal portion 23.

The first portion 231 is located on the side of the first end 24 of the external part 2.

The first portion 231 and the second portion 232 are preferably successive. The first portion extends over a length L₂₃₁. The second portion extends over a length L₂₃₂.

In another alternative embodiment, the thickness of the annular wall 20 of the external part 2, over the length of the longitudinal portion 23 is reduced such that:
over a first portion 233 of the longitudinal portion 23, the thickness of said annular wall 20 is monotonically decreasing,
over a second portion 234 of the longitudinal portion 23, the thickness of said annular wall 20 of the external part is monotonically increasing.

The first portion 233 and second portion 234 are preferably successive.

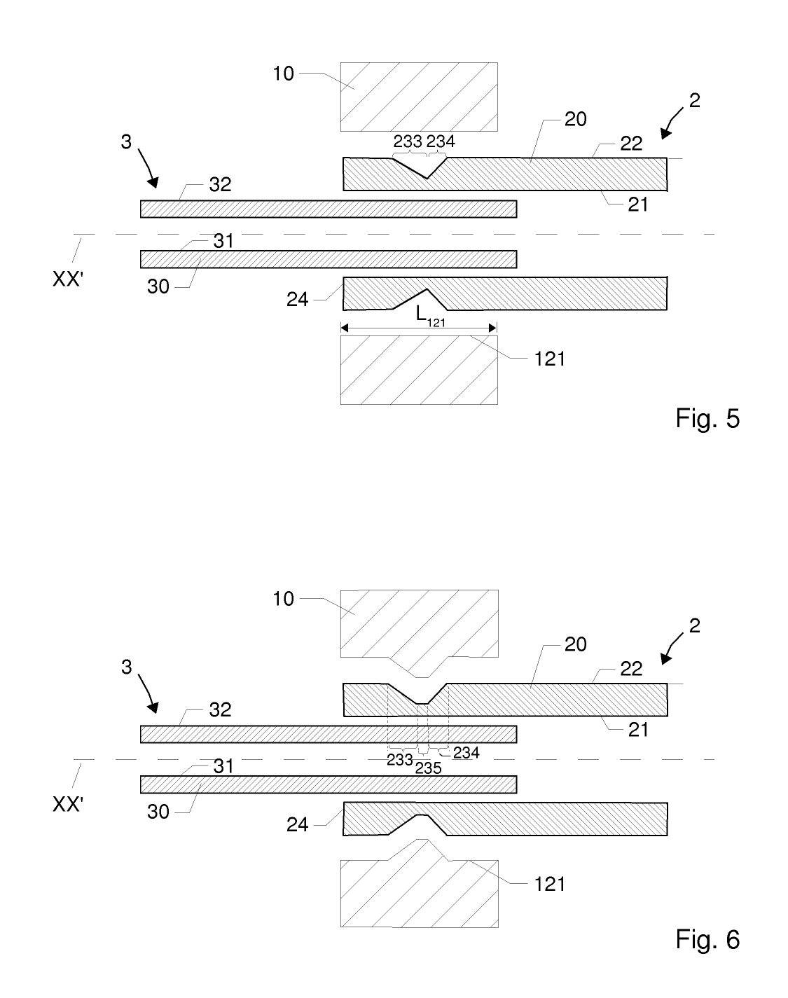

In the illustration given in FIG. 5, without this being limiting in any way, the longitudinal portion 23 does not start at the first end 24 of the external part 2.

In the illustration given in FIG. 5, without this being limiting in any way, the thickness of the annular wall 20 of the external part 2 is only reduced from the outer surface 22. No changes are made to the outer surface 32 of the annular wall 30 of the internal part 3. The inner diameter d₂₁ of the external part 2 remains approximately constant in the overlap region, especially over said longitudinal portion 23.

In another alternative embodiment, the thickness of the annular wall 20 of the external part 2, over the length of the longitudinal portion 23 is reduced such that:
over a first portion 233 of the longitudinal portion 23, the thickness of said annular wall 20 is monotonically decreasing,
over a second portion 234 of the longitudinal portion 23, the thickness of said annular wall 20 of the external part is monotonically increasing,
in a third portion 235 of the longitudinal portion 23, located between the first portion and the second portion, the thickness of said annular wall 20 of the external part is constant.

In the illustration given in FIG. 6, without this being limiting in any way, the longitudinal portion 23 does not start at the first end (24) of the external part 2.

In the illustration given in FIG. 6, without this being limiting in any way, the thickness of the annular wall 20 of the external part 2 is only reduced from the outer surface 22. No changes are made to the outer surface 32 of the annular wall 30 of the internal part 3. The inner diameter d₂₁ of the external part 2 remains approximately constant in the overlap region, especially over said longitudinal portion 23.

In a specific embodiment of the method, the method may comprise an additional step of forming of at least one pattern 37, on the outer surface 32 of the annular wall 30 of the internal part 3.

The at least one pattern 37 is designed to strengthen the connection of the two tubular parts 2, 3, once they are joined.

The at least one pattern 37 is located on the internal part 3, such that it is in the overlap region 25 of the two tubular parts 2, 3, when said two tubular parts are positioned one inside the other, for subsequent bonding. Preferably, said at least one pattern 37 is located in the longitudinal portion, when said two tubular pieces are positioned one inside the other, for their subsequent binding.

The at least one pattern 37 may be in the form of a protruding pattern or a sunken pattern.

A protruding pattern can be in the form of a radial projection with a peripheral or longitudinal bulge, for example, extending from the outer surface 32 of the annular wall 30 of the internal part 3 and projecting towards the outside the annular wall 30.

A sunken pattern may be in the form of a radial blind recess, a peripheral groove (as shown in FIG. 3) or longitudinal groove, extending in the thickness of the annular wall 30.

One method for designing the sunken pattern is, for example, to create the recess or groove by machining the outer surface 32 of the annular wall (30) of the inner part 3.

The internal part 3 can also comprise multiple patterns, either identical or different in shape.

The order in which the first step and the additional step are implemented is not mandatory and, depending on the method, may be performed in reverse of the described order or may be performed simultaneously without changing the result of said steps.

The method then comprises a step of positioning the tubular parts 2, 3 in the coil 10.

In a first phase, the two cylindrical tubular parts are positioned one inside the other, forming the overlap region 25.

The internal part 3 is engaged in the external part 2 such that the overlap region at least covers the longitudinal portion (23) of the external part 2 and the at least one pattern 37 of the internal part 3.

In a second phase, the two tubular parts 2, 3 are positioned in the tubular opening 12 of the coil 10.

The internal part 3 and external part 2 are preferably arranged in said coil such that all or a part of the overlap region 25 is opposite the peripheral surface 121 of the coil.

More particularly, the internal part 3 and external part 2 are arranged in the tubular opening 12 of the coil 10 such that the longitudinal portion 23 of the external part 2 is placed opposite to the active part 125 of the coil.

The overlap area 25 opposite to the active portion 125 is referred to as the working area. Said working area has a predetermined length, referred to as the working length. This working length corresponds to a maximum welding length between the internal part and the external part. In practice, the welding length is slightly less than this working length.

The internal part 3 and external part 2 are held in the tubular opening 12, coaxially with respect to each other, in an axial direction XX′ and with the tubular opening 12 of the coil 10, laid out in said axial direction XX′, by fastening means (not shown in the figures).

In a preferred example of an embodiment, when the longitudinal portion 23 starts from the first end 24, the external part 2 is positioned such that its first end 24 is positioned opposite to the peripheral surface 121.

The order in which the two phases are implemented is not mandatory and, depending on the method, may be performed in reverse of the described order, or performed simultaneously without changing the result of said steps.

At the end of this second step, the two tubular parts 2, 3 are positioned with each other and in the coil 10.

When the thickness of the annular wall 20 of the external part 2 is reduced by removing a layer of material from the outer surface 22, the outer surface 32 of the internal part 3 is approximately parallel to the inner surface 21 of the external part 2, as illustrated in FIGS. 3 and 4. The outer surface 22 of the external part 2 forms, in part, an angle with the peripheral surface 121 of the coil 10.

The method then comprises a step of bonding the two parts by magnetic pulses.

The working area is subjected to a magnetic field originating from the active part 125 of the coil 10 such that a pressure is exerted on the outer surface 22 of the annular wall 20 of the external part 2, or on an outer surface of the pusher when said pusher is required, and pushes it tightly against the outer surface 32 of the annular wall 30 of the internal part 3, causing them to bond permanently.

When the annular wall 20 of the external part 2 has a monotonically increasing thickness along the length L₂₃ of the longitudinal portion 23, as shown in FIG. 3, the internal part 3 and external part 2 are welded over a first length, referred to as the welding length, where the annular wall of the external part is thin, and are then crimped on a second length, referred to as the crimping length.

When the annular wall 20 of the external part 2 has a constant thickness followed by an increasing thickness along the length L₂₃ of the longitudinal portion 23, as shown in FIG. 4, the internal part 3 and external part 2 are welded over a greater length, because the annular wall of the external part is thinner over a greater length, and are then crimped.

The welding and crimping length is dependent upon the axial length of the coil 10 and energy used.

When the internal part 3, irrespective of the shape of the external part 2 at the longitudinal portion 23, comprises at least one pattern 37 on its outer surface 32, preferably located at the crimping length, said at least one pattern preferably allows locally enhancing the bonding between the tubular parts, increasing the contact area between the two tubular parts 2, 3 and improving the tensile strength of the bonding between said two tubular parts.

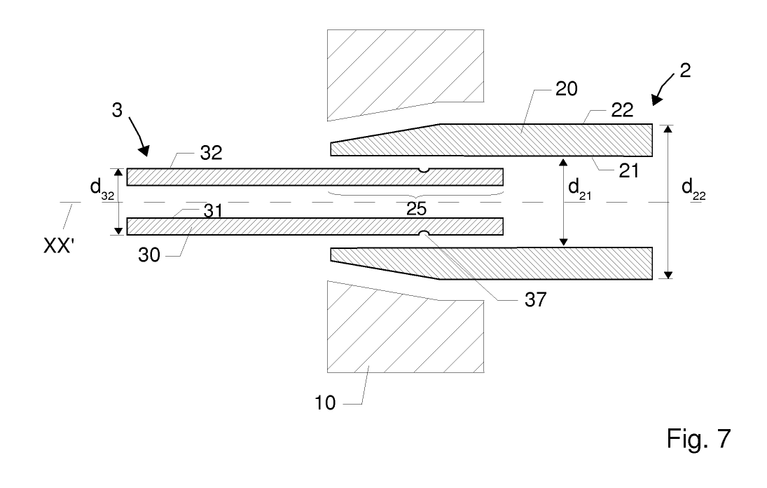

In an alternative embodiment of the coil as shown in FIGS. 6 and 7, the tubular opening 12 of the coil 10 may have a shape complementary to the outer surface 22 of the annular wall 20 of the external part 2, after the reduction in thickness of said external part over the longitudinal portion 23.

Such a shape of the tubular opening allows the coil to have a circular cross section whose diameter is tapered. Thus, at the longitudinal portion where the external part is thinner, the tubular opening of the coil has the smallest diameter. In such a configuration, the current is concentrated in this area of reduced diameter, which improves the performance of the magnetic pulse and thus facilitates the welding in said area.

The article obtained at the end of the joining method, such as a steering wheel of a motor vehicle for instance, comprises the two tubular parts 2, 3 connected together by a welded portion and then an attached crimped portion.

The above description clearly illustrates that through its various features and benefits, this invention achieves the goals it had set. In particular, it provides a magnetic pulse joining method suitable for joining very thick parts.

The method provides a stronger connection than what can be obtained with simple crimping, without compromising the structural strength of the outer part.

1-9. (canceled)

10. A magnetic pulse method for joining two tubular parts, an internal part and an external part, the external part comprising an annular wall having an outer surface, the external part having an inner diameter greater than an outer diameter of the internal part, the method comprising steps of:
on a longitudinal portion of the external part, reducing a thickness of the annular wall of the external part such that the annular wall has a decreasing thickness on the longitudinal portion, the thickness of the annular wall of the external part being reduced by removing a layer of material from the outer surface of the annular wall;
positioning the two tubular parts one inside the other to form an overlap region that at least covers the longitudinal portion;
positioning the two tubular parts opposite a coil such that the longitudinal portion is arranged opposite an active part of the coil; and
connecting the two tubular parts by magnetic pulses.

11. The joining method according to claim 10, wherein the thickness of the annular wall of the external part is reduced such that the thickness is monotonically decreasing towards a first end of the external part.

12. The joining method according to claim 10, wherein the thickness of the annular wall of the external part is reduced such that the thickness is constant over a first portion of the longitudinal portion and is monotonically increasing on a second portion of the longitudinal portion.

13. The joining method according to claim 10, wherein the thickness of the annular wall of the external part is reduced by removing a layer of material from an inner surface of the external part.

14. The joining method according to claim 10, wherein the thickness of the annular wall of the external part is reduced by machining.

15. The joining method according to claim 10, further comprising a step of forming at least one pattern on an outer surface of an annular wall of the internal part, the forming step being carried out prior to the positioning steps.

16. The joining method according to claim 15, wherein said at least one pattern is produced by machining.

17. The joining method according to claim 15, wherein the step of forming said at least one pattern and the step of reducing the thickness of the annular wall of the external part are carried out simultaneously.

18. An article comprising two tubular parts, the external part comprising a decreasing thickness over the longitudinal portion; wherein the two tubular parts are joined together, at the longitudinal portion, by a combined welded part and crimped part obtained using the joining method according to claim 10.
